(19) United States
(12) Patent Application Publication
(10) Pub. No.: US 2021/0143800 A1
(43) Pub. Date: May 13, 2021

(54) HYBRID STANDARD CELL AND METHOD OF DESIGNING INTEGRATED CIRCUIT USING THE SAME

(71) Applicant: SAMSUNG ELECTRONICS CO., LTD., SUWON-SI (KR)

(72) Inventors: JEONGJIN LEE, SUWON-SI (KR); MINSU KIM, HWASEONG-SI (KR); AHREUM KIM, DAEGU (KR)

(21) Appl. No.: 16/891,521

(22) Filed: Jun. 3, 2020

(30) Foreign Application Priority Data
Nov. 7, 2019 (KR) 10-2019-0142058

(51) Int. Cl. H03K 3/012; H03K 3/3562; H01L 27/092; G06F 30/3953; G06F 30/398; G06F 30/392

(52) U.S. Cl. CPC H03K 3/012; H03K 3/35625; H01L 27/0924; G06F 2119/06; G06F 30/398; G06F 30/392; G06F 30/3953

(57) ABSTRACT

The present disclosure relates to a hybrid standard cell that includes a semiconductor substrate, a first power rail, a second power rail, a high-speed transistor region and a low-power transistor region. The first power rail and the second power rail are formed above the semiconductor substrate and extend in a first direction and arranged sequentially in a second direction perpendicular to the first direction. The high-speed transistor region and the low-power transistor region are adjacent to each other in the first direction and arranged in a row region between the first power rail and the second power rail. An operation speed of a high-speed transistor formed in the high-speed transistor region is higher than an operation speed of a low-power transistor formed in the low-power transistor region, and a power consumption of the high-speed transistor is lower than a power consumption of the high-speed transistor.

### CROSS-REFERENCE TO RELATED APPLICATION

This U.S. non-provisional application claims priority under 35 USC § 119 to Korean Patent Application No. 10-2019-0142058, filed on Nov. 7, 2019, in the Korean Intellectual Property Office (KIPO), the disclosure of which is incorporated by reference herein in its entirety.

### BACKGROUND

### 1. Technical Field

Example embodiments relate generally to semiconductor integrated circuits, and more particularly to a hybrid standard cell and a method of designing an integrated circuit using the hybrid standard cell.

### 2. Discussion of the Related Art

Semiconductors devices include a variety of integrated circuits (IC). For example, application-specific integrated circuits (ASIC) are designed for distinct applications, and general purpose ICs may be used for various applications.

Some ASICs use a standard cell design. Standard cells are implemented as either a 2-fin structure, which enables rapid operation speed, or a 1-fin structure, which can result in low power consumption. Placement in an ASIC refers to the process of locating gates in a netlist. Routing in an ASIC refers to the signal and power lines. Replacing a standard cell structure may result in placement and routing processes to be performed repeatedly.

However, performing the placement and routing processes more than once reduces design efficiency and speed. Therefore, there is a need in the art to reduce the number of placement and routing processes in designing an ASIC.

### SUMMARY

Some example embodiments may provide a hybrid standard cell and a method of designing an integrated circuit using the hybrid standard cell, capable of reducing power consumption of the integrated circuit.

According to example embodiments, a hybrid standard cell includes a semiconductor substrate; a first power rail and a second power rail formed above the semiconductor substrate, wherein the first power rail and the second power rail extend in a first direction and are arranged sequentially in a second direction perpendicular to the first direction; and a high-speed transistor region and a low-power transistor region adjacent to the high-speed transistor region in the first direction and arranged in a row region between the first power rail and the second power rail, an operation speed of a high-speed transistor formed in the high-speed transistor region being higher than an operation speed of a low-power transistor formed in the low-power transistor region, and a power consumption of the high-speed transistor being lower than a power consumption of the high-speed transistor.

According to example embodiments, a hybrid standard cell includes a semiconductor substrate; a plurality of power rails formed above the semiconductor substrate, extending in a first direction, and arranged sequentially in a second direction perpendicular to the first direction; and at least one high-speed transistor region and at least one low-power transistor region arranged in one or more row regions between the plurality of power rails, wherein one or more boundaries of the at least one high-speed transistor region and the at least one low-power transistor region correspond to one or more active break regions extending in the second direction, a first channel width of a high-speed transistor formed in the at least one high-speed transistor region being greater than a second channel width of a low-power transistor formed in the at least one low-power transistor region.

According to example embodiments, a method of designing an integrated circuit includes receiving input data for an integrated circuit; providing a normal standard cell library including a plurality of normal standard cells; providing a hybrid standard cell library including at least one hybrid standard cell, wherein the hybrid standard cell is configured to perform a same function as a corresponding normal standard cell among the plurality of normal standard cells, wherein the hybrid standard cell has a lower power consumption than the corresponding normal standard cell; and generating output data by performing placement and routing based on the input data, the normal standard cell library and the hybrid standard cell library.

According to example embodiments, a method of designing an integrated circuit, the method includes receiving input data for an integrated circuit; performing placement using normal standard cells based on the input data; performing signal routing based on the placement; determining that a power condition is not satisfied based at least in part on the placement and the signal routing; replacing at least one of the normal standard cells with a hybrid standard cell based on the determination; and generating output data for the integrated circuit based on the hybrid standard cell.

The hybrid standard cell and the method of designing an integrated circuit according to example embodiments may efficiently reduce the power consumption of the hybrid standard cell and the integrated circuit including the hybrid standard cell by efficiently disposing the high-speed transistor and the low-power transistor. The methods of designing an integrated circuit according to example embodiments may enhance design efficiency by replacing the normal standard cell with the hybrid standard cell after replacement and routing are completed.

### BRIEF DESCRIPTION OF THE DRAWINGS

Example embodiments of the present disclosure will be more clearly understood from the following detailed description taken in conjunction with the accompanying drawings.

FIG. 1 is a diagram illustrating a hybrid standard cell according to example embodiments.

FIGS. 2A, 2B and 2C are diagrams illustrating a high-speed transistor and a low-power transistor included in a hybrid standard cell according to example embodiments.

FIG. 3 is a diagram illustrating a layout of an example standard cell.

FIGS. 4A, 4B, 4C and 4D are cross-sectional views of a standard cell that may have the same layout as the standard cell of FIG. 3.

FIGS. 5A, 5B, 6A and 6B are diagrams illustrating examples of a fin field effect (FinFET) transistor.

FIG. 7 is a circuit diagram illustrating a 1-bit flip-flop according to example embodiments.

FIGS. 8A, 8B, 9A and 9B are diagrams illustrating example embodiments of a layout of a hybrid standard cell corresponding to the 1-bit flip-flop of FIG. 7.

FIG. 10 is a circuit diagram illustrating a 2-bit flip-flop according to example embodiments.

FIGS. 11A and 11B are diagrams illustrating an example embodiment of a layout of a hybrid standard cell corresponding to the 2-bit flip-flop of FIG. 10.

FIGS. 12A and 12B are cross-sectional views of a standard cell that may have the same layout as the standard cell of FIG. 3.

FIGS. 13A and 13B are diagrams illustrating an example embodiment of a layout of a hybrid standard cell corresponding to the 1-bit flip-flop of FIG. 7.

FIG. 14 is a flow chart illustrating a method of designing an integrated circuit according to example embodiments.

FIG. 15A is a block diagram illustrating a designing system of an integrated circuit according to example embodiments.

FIG. 15B is a flow chart illustrating an example operation of the designing system of FIG. 15A.

FIG. 16 is a diagram illustrating pin points of the standard cell of FIG. 3.

FIGS. 17A and 17B are diagrams for describing pin points for signal output and signal input of a cell.

FIG. 18 is a diagram illustrating a layout of an integrated circuit according to example embodiments.

FIG. 19 is a block diagram illustrating a mobile device according to example embodiments.

### DETAILED DESCRIPTION OF THE EMBODIMENTS

The present disclosure relates to cell design for semiconductors. More specifically, embodiments of the present disclosure relate to a single standard cell including a high-speed transistor and a low power transistor.

Standard cells may be implemented with either a 2-fin structure (e.g., for enabling rapid operation speed), or a 1-fin structure (e.g., for enabling low power consumption). Placement and routing processes are repeatedly performed when the standard cell of one structure is replaced with the standard cell of the other structure. The design efficiency and performance of an integrated circuit may depend on the configuration and layout of the standard cell.

Standard cells with fixed functions may be used to design integrated circuits (IC). For example, standard cells may use predetermined architectures and may be stored in specific cell libraries. In some cases, the cells may be retrieved from the cell libraries and placed into desired locations on an integrated circuit layout. Routing may then be performed to connect the standard cells with each other and with other cells.

Embodiments of the present disclosure use a hybrid standard cell that includes a high-speed transistor region (HSTR) and a low-power transistor region (LPTR). High-speed transistors are formed in the HSTR and low-power transistors are formed in the LPTR. Boundaries of the HSTR and the LPTR may correspond to active break regions used to cut transistor channels. In some examples, after placement and routing are completed using normal standard cells, at least one normal standard cell may be replaced with the hybrid standard cell without repeated placement and routing.

Various example embodiments will be described more fully hereinafter with reference to the accompanying drawings, in which some example embodiments are shown. In the drawings, like numerals refer to like elements throughout. The repeated descriptions may be omitted.

Hereinafter, structures of a hybrid standard cell and an integrated circuit according to example embodiments are described using a first direction X, a second direction Y and a third direction Z in a three-dimensional space. The first direction X may be a row direction, the second direction Y may be a column direction, and the third direction Z may be a vertical direction. The first direction X, the second direction Y, and the third direction Z may intersect, e.g., may be orthogonal or perpendicular to one another.

FIG. 1 is a diagram illustrating a hybrid standard cell according to example embodiments.

Referring to FIG. 1, a hybrid standard cell HSC may include a semiconductor substrate, a first power rail PR1, a second power rail PR2, a high-speed transistor region HSTR and a low-power transistor region LPTR. The hybrid standard cell HSC may be used in designing an integrated circuit as will be described below with reference to FIGS. 14 through 18.

The first power rail PR1 and the second power rail PR2 may be formed above the semiconductor substrate and may extend in a first direction X. Additionally or alternatively, the first power rail PR1 and the second power rail PR2 may be arranged sequentially in a second direction Y perpendicular to the first direction X. The high-speed transistor region HSTR and the low-power transistor region LPTR are adjacent in the first direction X and arranged in a row region RG between the first power rail PR1 and the second power rail PR2.

As illustrated in FIG. 1, boundaries of the high-speed transistor region HSTR and the low-power transistor region LPTR may correspond to active break regions ABR1, ABR2 and ABR3 extending in the second direction Y, where the active break region is used to cut channels of transistors.

The hybrid standard cell, according to example embodiments, may include one row region RG defined by the two power rails PR1 and PR2 as illustrated in FIG. 1, or two or more row regions defined by three or more power rails. Additionally or alternatively, FIG. 1 illustrates, for convenience of illustration and description, that the row region RG includes the one high-speed transistor region HSTR and the one low-power transistor region LPTR adjacent to each other in the first direction X. Each row region may include two or more high-speed transistor regions and/or two or more low-power transistor regions.

An operation speed of a high-speed transistor HST may be higher than an operation speed of a low-power transistor. The operation speed of a high-speed transistor HST may be formed in the high-speed transistor region. The operation speed of a low-power transistor LPT may be formed in the low-power transistor region. Additionally or alternatively, a power consumption of the high-speed transistor HST may be lower than a power consumption of the high-speed transistor HST.

As such, the hybrid standard cell HSC according to example embodiments may efficiently reduce the power consumption of the hybrid standard cell HSC and the integrated circuit including the hybrid standard cell HSC by efficiently disposing the high-speed transistor HST and the low-power transistor LPT.

FIGS. 2A, 2B and 2C are diagrams illustrating a high-speed transistor and a low-power transistor included in a hybrid standard cell according to example embodiments.

Referring to FIG. 2A, the high-speed transistor HST and the low-power transistor LPT may be implemented as a fin field effect transistor (FinFET). The FinFET will be further described below with reference to FIGS. 3 through 5B. In case of the FinFET, semiconductor fins, which protrude to the gate line GT from the semiconductor substrate SUB, function as a channel CHNN. When the FinFET is turned on, the electrical channel is formed on the three surfaces of the fin contacting the gate line GT so that the turn-on current may flow in the first direction X through the electrical channel. FIG. 2A illustrates examples of the high-speed transistor HST including the two fins and the low-power transistor LPT including the one fin.

As such, the number of the semiconductor fins formed in the high-speed transistor HST may be greater than the number of the semiconductor fins formed in the low-power transistor region LPT. Accordingly, a first channel width of the high-speed transistor HST may be greater than a second channel width of the low-power transistor LPT. The channel width indicates a length of the electrical channel, which is perpendicular to the turn-on current. In case of FIG. 2A, the first channel width may be double the second channel width.

Referring to FIGS. 2B and 2C, the high-speed transistor HST and the low-power transistor LPT may be implemented as a multi-bridge channel field effect transistor (MBCFET). FIG. 2B illustrates an example embodiment of a nanowire MBCFET, and FIG. 2C illustrates an example embodiment of a nanosheet type MBCFET. The MBCFET will be further described below with reference to FIGS. 12A and 12B. In case of the MBCFET, the semiconductor patterns, which are formed and disposed in the vertical direction Z in the gate line GT, function as a channel CHNN. When the MBCFET is turned on, the electrical channel is formed on the whole surfaces of the semiconductor patterns contacting the gate line GT so that the turn-on current may flow in the first direction X through the electrical channel. FIG. 2B illustrates examples of the high-speed transistor HST including the six nanowires and the low-power transistor LPT including the three nanowires. FIG. 2C illustrates examples of the high-speed transistor HST including the three nanosheets of the larger length L1 in the first direction X and the low-power transistor LPT including the three nanosheets of the smaller length L2 in the first direction X.

As such, the quantity or the width of the channels formed in the high-speed transistor HST may be greater than the quantity or the width of the channels formed in the low-power transistor LPT. Accordingly, the first channel width of the high-speed transistor HST may be greater than the second channel width of the low-power transistor LPT. In case of FIG. 2B, the first channel width is double the second channel width. In case of FIG. 2C, the first channel width is L1/L2 times the second channel width.

Hereinafter, a structure of a standard cell is described with reference to FIGS. 3 through 4D to facilitate understanding of example embodiments.

FIG. 3 is a diagram illustrating a layout of an example standard cell, and FIGS. 4A, 4B, 4C and 4D are cross-sectional views of a standard cell that may have the same layout as the standard cell of FIG. 3.

FIGS. 4A, 4B, 4C and 4D illustrate a portion of the standard cell SCL that includes a fin field effect transistor (FinFET). FIG. 4A is a cross-sectional view of the standard cell SCL of FIG. 3 cut along a line A-A′. FIG. 4B is a cross-sectional view of the standard cell SCL of FIG. 3 cut along a line B-B′. FIG. 4C is a cross-sectional view of the standard cell SCL of FIG. 3 cut along a line C-C′. FIG. 4D is a cross-sectional view of the active break region ABR included in the standard cell SCL of FIG. 3.

Referring to FIGS. 3, 4A, 4B, 4C and 4D, the standard cell SCL may be formed at a substrate 110 with an upper surface 110A that extends in a horizontal direction, in other words, the first direction X and the second direction Y.

In some example embodiments, the substrate 110 may include a semiconductor such as Si or Ge or a compound semiconductor such as SiGe, SiC, GaAs, InAs, or InP. In some example embodiments, the substrate 110 may have a silicon on insulator (SOI) structure. The substrate 110 may include a conductive area such as an impurity-doped well or an impurity-doped structure.

The standard cell SCL includes a first device area RX1, a second device area RX2 and an active cut area ACR separating the first and second device areas RX1 and RX2. In each of the first and second device areas RX1 and RX2, a plurality of fin-type active areas AC protruded from the substrate 110 may be formed.

The plurality of active areas AC are extended in parallel to one another in the first direction X. A device isolation layer 112 is formed between the plurality of active areas AC on the substrate 110. The plurality of active areas AC protrude from the device isolation layer 112 in the form of fins.

A plurality of gate insulation layers 118 and a plurality of gate lines PC 11, 12, 13, 14, 15 and 16 are formed on the substrate 110. The gate lines PC 11, 12, 13, 14, 15 and 16 are extended in the second direction Y crossing the plurality of active areas AC. The plurality of gate insulation layers 118 and the plurality of gate lines PC 11, 12, 13, 14, 15 and 16 may be extended while covering an upper surface and two sidewalls of each of the active areas AC and an upper surface of the device isolation layer 112. A plurality of metal oxide semiconductor (MOS) transistors may be formed along the plurality of gate lines PC 11, 12, 13, 14, 15 and 16. The MOS transistors may have a three-dimensional structure in which channels are formed in the upper surface and the two sidewalls of the active areas AC.

The gate insulation layers 118 may be formed of a silicon oxide layer, a high-k dielectric layer, or a combination of these. The plurality of gate lines PC 11, 12, 13, 14, 15 and 16 are extended on the gate insulation layers 118 across the plurality of active areas AC while covering the upper surface and the two side surfaces of each of the active areas AC. The gate lines PC 11, 12, 13, 14, 15 and 16 may have a structure in which a metal nitride layer, a metal layer, a conductive capping layer, and a gap-fill metal layer are sequentially stacked.

A plurality of conductive contacts CA and CB are formed at a first layer LY1 on the active areas AC. The plurality of conductive contacts CA and CB include a plurality of first contacts CA 21, 22, 23, 24, 25, 31, 32, 33, 34 and 35 connected to a source/drain area 116 of the active areas AC and a plurality of second contacts CB 41, 42 and 43 connected to the gate lines 11, 12, 13, 14, 15 and 16.

The plurality of conductive contacts CA and CB may be insulated from each other by a first interlayer insulation layer 132 that covers the active areas AC and the gate lines GL. The plurality of conductive contacts CA and CB may have an upper surface at the same level as an upper surface of the first interlayer insulation layer 132. The first interlayer insulation layer 132 may be formed of a silicon oxide layer, but is not limited thereto. A second interlayer insulation layer 134 and a plurality of lower via contacts V0 51, 52, 53, 54, 55, 56, 57, 58, 59, 60, 61 and 62 that pass through the second interlayer insulation layer 134 are formed on the first interlayer insulation layer 132. The second interlayer insulation layer 134 may be formed of a silicon oxide layer, but is not limited thereto. A plurality of wirings M1 71, 72, 73, 74, 75, 76, 77 and 78 that are extended in the horizontal direction at a second layer LY2 which is higher than the first layer LY1 are formed on the second interlayer insulation layer 134.

Each of the wirings M1 may be connected to one contact of the plurality of conductive contacts CA and CB via one lower via contact V0 of the plurality of lower via contacts V0. Each contact of the plurality of lower via contacts V0 may be connected to one of the plurality of conductive contacts CA and CB by passing through the second interlayer insulation layer 134. The plurality of lower via contacts V0 may be insulated from one another by the second interlayer insulation layer 134.

The wirings 71˜78 may include an internal connection wiring that electrically connects a plurality of areas in the standard cell SCL. For example, the internal connection wiring 78 may electrically connect the active area AC in the first device area RX1 and the active area AC in the second device area RX2 through the lower via contacts 55 and 58 and the first contacts 24 and 33.

The first power rail 71 may be connected to the active area AC which is in the first device area RX1, and the second power rail 72 may be connected to the active area AC which is in the second device area RX2. One of the first and second power rails 71 and 72 may be a wiring for supplying a power supply voltage and the other of the first and second power rails 71 and 72 may be a wiring for supplying a ground voltage.

The first power rail 71 and the second power rail 72 may be extended in the first direction X in parallel to each other on the second layer LY2. In some embodiments, the power rails 71 and 72 may be formed at the same time with the other wirings 73˜78. The wirings M1 may be formed to pass through a third interlayer insulation layer 136. The third interlayer insulation layer 136 may insulate the wirings M1 from one another.

A height CH of the standard cell SCL may be defined by the distance along the second direction Y between the first power rail 71 and the second power rail 72. Additionally or alternatively, a width CW of the standard cell SCL may be defined along the first direction X parallel to the power rails 71 and 72.

The wirings M may have to meet limitations due to a minimum spacing rule. For example, the wirings M may have to meet limitations according to a “tip-to-side” restriction as will be described below with reference to FIG. 21A and a “corner rounding” restriction as will be described below with reference to FIG. 21B. The size and disposition of the wirings M may be limited by such restrictions.

The lower via contacts V0 and the wirings M1 may have a stacked structure of a barrier layer and a wiring conductive layer. The barrier layer may be formed, for example, of TiN, TaN, or a combination of these. The wiring conductive layer may be formed, for example, of W, Cu, an alloy thereof, or a combination thereof. A CVD method, an ALD method, or an electroplating method may be used to form the wirings M1 and the lower via contacts V0.

As illustrated in FIG. 4D, the semiconductor fins, for example, the active areas AC may be removed in the active break region ABR. The active break region ABR may extend in the second direction Y to cut the semiconductor fins for the electrical channels. As described with reference to FIG. 1, the high-speed transistor region HSTR and the low-power transistor region LPTR may correspond to the regions divided by the active break regions ABR.

FIGS. 5A, 5B, 6A and 6B are diagrams illustrating examples of a fin field effect (FinFET) transistor.

FIG. 5A is a perspective view of an example of the high-speed transistor HST and FIG. 5B is a cross-sectional view taken along line AA-AA′ of FIG. 5A. FIG. 6A is a perspective view of an example of the low-power transistor LPT and FIG. 6B is a cross-sectional view taken along line AA-AA′ of FIG. 6A.

Referring to FIGS. 5A through 6B, the fin transistor may be a bulk-type fin transistor and may include a substrate SUB, a first insulating layer IL1, a second insulating layer IL2, fins FN, and a conductive line CL. Hereinafter, the conductive line CL is referred to as a gate electrode.

The substrate SUB may be a semiconductor substrate. For example, the semiconductor substrate may include silicon, silicon-on-insulator, silicon-on-sapphire, germanium, or gallium arsenide. The substrate SUB may be a P-type substrate and may be used as an active region AR1. The fins FN may be connected to the substrate SUB. In exemplary embodiments of the present inventive concept, the fins FN may be n+-doped or p+-doped active regions that vertically protrude from the substrate SUB.

The first and second insulating layers IL1 and IL2 may include an insulating material. For example, the insulating material may include an oxide film, a nitride film, or an oxynitride film. The first insulating layer IL1 may be disposed on the fins FN. The first insulating layer IL1 may be disposed between the fins FN and the gate electrode CL. Additionally or alternatively, the first insulating layer IL1 may be used as a gate insulating film. The second insulating layer IL2 may be disposed in spaces between the fins FN and have a predetermined height. The second insulating layer IL2 may be disposed between the fins FN and may be used as an element isolation film.

The gate electrode CL may be disposed on the first and second insulating layers IL1 and IL2. Accordingly, the gate electrode CL may have a structure that surrounds the fins FN and the first and second insulating layers IL1 and IL2. In other words, the fins FN may have structures that are disposed in the gate electrode CL. The gate electrode CL may include metal materials such as tungsten (W) and tantalum (Ta), nitrides thereof, silicides thereof, or doped polysilicon. The gate electrode CL may be formed by a deposition process.

In some example embodiments, the high-speed transistor HST may include the two semiconductor fins FN as illustrated in FIGS. 5A and 5B, and the low-power transistor LPT may include the one semiconductor fin FN as illustrated in FIGS. 6A and 6B. As such, the number of the semiconductor fins of the high-speed transistor HST may be greater than the number of the semiconductor fins of the low-power transistor LPT so that the first channel width of the high-speed transistor HST may be greater than the second channel width of the low-power transistor LPT. As a result, the operation speed of the high-speed transistor HST may be higher than the operation speed of the low-power transistor LPT and the power consumption of the low-power transistor LPT may be lower than the power consumption of the high-speed transistor HST.

FIG. 7 is a circuit diagram illustrating a 1-bit flip-flop according to example embodiments.

An integrated circuit 600 of FIG. 7 corresponds to an example of a 1-bit flip-flop of a master-slave type. Referring to FIG. 7, an integrated circuit 600 may include a first flip-flop FF1 and may further include an input circuit CIN and an output circuit COUT.

The first flip-flop FF1 may include a first master latch ML1 and a first slave latch SL1. The first master latch ML1 may latch a first input signal MA1 in synchronization with the clock signal CK and an inverted clock signal CKN to generate a first master output signal SA1. The first slave latch SL1 may latch the first master output signal SA1 in synchronization with the clock signal CK and the inverted clock signal CKN to generate a first slave output signal SC1.

The first master latch ML1 may include a first tri-state inverter TS11, a second tri-state inverter TS12, and an inverter INV11. The first slave latch SL1 may include a third tri-state inverter TS13, a fourth tri-state inverter TS14, and an inverter INV12.

The first through fourth tri-state inverters TS11-TS14 operate in synchronization with the clock signal CK and the inverted clock signal CKN. An input node of the first tri-state inverter TS11 corresponds to a node of the first input signal MA1. An output node of the first tri-state inverter TS11 corresponds to a node of the first master output signal SA1. In other words, the first tri-state inverter TS11 receives the first input signal MA1 and outputs the first master output signal SA1. The second tri-state inverter TS12 receives a first inverted master output signal MB1 and outputs the first master output signal SA1. The third tri-state inverter TS13 receives the first master output signal SA1 and outputs the first slave output signal SC1. The fourth tri-state inverter TS14 receives a first inverted slave output signal SB1 and outputs the first slave output signal SC1.

The input circuit CIN may include inverters INV1 and INV2 and tri-state inverters TS1 and TS2. The input circuit CIN may operate in synchronization with a scan enable signal SE and an inverted scan enable signal SEN to provide one of a first scan input signal SI1 and a first data signal D1 as the first input signal MA1. Additionally or alternatively, the input circuit CIN may provide the clock signal CK and the inverted clock signal CKN. The output circuit COUT may include an inverter INV3 to buffer the first slave output signal SC1, and output an final output signal Q1.

FIGS. 8A, 8B, 9A and 9B are diagrams illustrating example embodiments of a layout of a hybrid standard cell corresponding to the 1-bit flip-flop of FIG. 7.

In FIGS. 8A through 9B, a scan enable inverter SEINV corresponds to the inverter INV1 in FIG. 7, an input multiplexer IMUX corresponds to the tri-state inverters TS1 and TS2 in FIG. 7, a master latch ML1 corresponds to the master latch ML1 in FIG. 7, a slave latch SL1 corresponds to the slave latch SL1 in FIG. 7, an output driver ODRV1 corresponds to the inverter INV3 in FIG. 7, and a clock inverter CKINV corresponds to the inverter INV2 in FIG. 7.

FIG. 8A illustrates a hybrid standard cell HSC1 with a combination of the 1-fin structure and the 2-fin structure, and FIG. 8B illustrates a corresponding normal standard cell NSC1 with the 2-fin structure.

Referring to FIG. 8A, the hybrid standard cell HSC1 includes a first power rail PR1, a second power rail PR2, a first low-power transistor region LPTR1, a first high-speed transistor region HSTR1 and a second high-speed transistor region HSTR2. The aforementioned components may be sequentially arranged in the first direction X in a row region RG between the first power rail PR1 and the second power rail PR2 such that the boundaries of the first low-power transistor region LPTR1, the first high-speed transistor region HSTR1 and the second high-speed transistor region HSTR2 correspond to first through fourth active break regions ABR1˜ABR4.

The number of the semiconductor fins FN1, FN2, FN3 and FN4 formed in the first and second high-speed transistor regions HSTR1 and HSTR2 is greater than the number of the semiconductor fins FN1 and FN3. In other words, the high-speed transistors of the 2-fin structure may be formed in the first and second high-speed transistor regions HSTR1 and HSTR2, and low-power transistors of the 1-fin structure may be formed in the first low-power transistor region LPTR1.

As illustrated in FIG. 8A, the first low-power transistor region LPTR may include the scan enable inverter SEINV, the input multiplexer IMUX and the master latch ML1, the first high-speed transistor region HSTR may include the clock inverter CKINV and the slave latch SL1, and the second high-speed transistor region HSTR may include the output driver ODRV1. As such, the layout of the hybrid standard cell HSC1 may be designed such that the clock inverter CKINV and the output driver ODRV1 may be formed in the high-speed transistor regions HSTR1 and HSTR2.

The normal standard cell NSC1 of FIG. 8B is substantially the same as the hybrid standard cell HSC1 of FIG. 8A, except that the first low-power transistor region LPTR1 of FIG. 8A is replaced with a third high-speed transistor region HSTR3 of FIG. 8B. Therefore, repeated descriptions are omitted.

As illustrated in FIGS. 8A and 8B, the cannel width of the transistors formed in the normal standard cell NSC1 corresponding to the hybrid standard cell HSC1 may be the same as the first channel width of the high-speed transistors formed in the high-speed transistor regions of the hybrid standard cell HSC1. As such, the hybrid standard cell HSC1 may replace the corresponding normal standard cell NSC1 with the same function as the hybrid standard cell HSC1 to reduce the power consumption.

In the field of mobile device, reducing the size and the power consumption of products through optimized designs is useful. In designing a system on chip (SoC), flip-flops have significant effects on the size and the power consumption of the SoC. For example, in case of the FinFET process, the 1-fin structure is applied for the low-power flip-flop and the 2-fin structure is applied for the high-speed flip-flop.

Among the elements in the flip-flop, the clock inverter and the output driver use a higher operation speed to enhance the performance of the flip-flop. In some cases, it may not be feasible to implement some elements as the 1-fin structure and the other elements as the 2-fin structure due to limits of the process of the active region. According to example embodiments, the active break regions may be used as the boundaries of changing the fin-structure.

The additional active break regions may be added to the regions with different fin-structure from the adjacent regions, but the additional active break region increases the size of the circuit. The layout of the circuit may be changed so that the circuits of the same fin-structure may be disposed adjacent to each other, but the inefficient layout may be caused because due to the design concentrating the active regions. In general, the metal routing of the 1-fin flip-flop is different from the metal routing of the 2-fin flip-flop. Therefore, the integrated circuit including the flip-flops of the different fin-structures is inefficient.

The hybrid standard cell HSC1 of FIG. 8A according to example embodiments has substantially the same structure as the corresponding normal standard cell NSC1 of FIG. 8B, except the inner fin-structures. Therefore, the hybrid standard cell HSC1 may be implemented using the established active break regions of the corresponding normal standard cell NSC1.

FIG. 9A illustrates a hybrid standard cell HSC2 with a combination of the 1-fin structure and the 2-fin structure, and FIG. 9B illustrates a corresponding normal standard cell NSC2 with the 2-fin structure.

Referring to FIG. 9A, the hybrid standard cell HSC2 includes a first power rail PR1, a second power rail PR2, a first high-speed transistor region HSTR1, a first low-power transistor region LPTR1 and a second high-speed transistor region HSTR2. The aforementioned components may be arranged sequentially in the first direction X in a row region RG between the first power rail PR1 and the second power rail PR2 such that the boundaries of the first low-power transistor region LPTR1, the first high-speed transistor region HSTR1 and the second high-speed transistor region HSTR2 correspond to first through fourth active break regions ABR1˜ABR4.

As illustrated in FIG. 9A, the first high-speed transistor region HSTR1 may include the scan enable inverter SEINV, the input multiplexer IMUX, and the clock inverter CKINV. The first low-power transistor region LPTR1 may include the master latch ML1 and the slave latch SL1. The second high-speed transistor region HSTR2 may include the output driver ODRV1. As such, the layout of the hybrid standard cell HSC2 may be designed such that the clock inverter CKINV and the output driver ODRV1 may be formed in the high-speed transistor regions HSTR1 and HSTR2.

The normal standard cell NSC2 of FIG. 9B is substantially the same as the hybrid standard cell HSC1 of FIG. 9A, except that the first low-power transistor region LPTR1 of FIG. 9A is replaced with a third high-speed transistor region HSTR3 of FIG. 9B. Therefore, repeated descriptions are omitted.

FIG. 10 is a circuit diagram illustrating a 2-bit flip-flop according to example embodiments.

An integrated circuit 700 of FIG. 10 corresponds to an example of a 2-bit flip-flop of a master-slave type. Referring to FIG. 10, an integrated circuit 700 may include a first flip-flop FF1 and a second flip-flop FF2 and may further include an input circuit CIN and an output circuit COUT. The first flip-flop FF1 of FIG. 10 is substantially the same as the first flip-flop FF1 of FIG. 7, and the repeated descriptions are omitted.

The second flip-flop FF2 may include a second master latch ML2 and a second slave latch SL2. The second master latch ML2 may latch a second input signal MA2 in synchronization with the clock signal CK and the inverted clock signal CKN to generate a second master output signal SA2. The second slave latch SL2 may latch the second master output signal SA2 in synchronization with the clock signal CK and the inverted clock signal CKN to generate a second slave output signal SC2.

The second master latch ML2 may include a fifth tri-state inverter TS21, a sixth tri-state inverter TS22 and an inverter INV21. The second slave latch SL2 may include a seventh tri-state inverter TS23, an eighth tri-state inverter TS24 and an inverter INV22.

The fifth through eighth tri-state inverters TS21-TS24 operate in synchronization with the clock signal CK and the inverted clock signal CKN. The fifth tri-state inverter TS21 receives the second input signal MA2 and outputs the second master output signal SA2. The sixth tri-state inverter TS22 receives a second inverted master output signal MB2 and outputs the second master output signal SA2. The seventh tri-state inverter TS23 receives the second master output signal SA2 and outputs the second slave output signal SC2. The eighth tri-state inverter TS24 receives a second inverted slave output signal SB2 and outputs the second slave output signal SC2.

The input circuit CIN may include inverters INV1 and INV2 and tri-state inverters TS1-TS4. The input circuit CIN may operate in synchronization with a scan enable signal SE and an inverted scan enable signal SEN to provide one of a first scan input signal SI1 and a first data signal D1 as the first input signal MA1. The input circuit CIN may also provide one of a second scan input signal SI2 and a second data signal D2 as the second input signal MA2. Additionally or alternatively, the input circuit CIN may provide the clock signal CK and the inverted clock signal CKN. The output circuit COUT may include inverters INV3 and INV4 to buffer the first slave output signal SC1 and the second slave output signal SC2, and output final output signals Q1 and Q2.

FIGS. 11A and 11B are diagrams illustrating an example embodiment of a layout of a hybrid standard cell corresponding to the 2-bit flip-flop of FIG. 10.

In FIGS. 11A and 11B, a scan enable inverter SEINV corresponds to the inverter INV1 in FIG. 10, an input multiplexer IMUX corresponds to the tri-state inverters TS1 and TS2 in FIG. 10, a first master latch ML1, a second master latch ML2, a first slave latch SL1 and a second slave latch SL2 correspond to the latches ML1, ML2, SL1 and SL2 in FIG. 10, a first output driver ODRV1 and a second output driver ODRV2 correspond to the inverters INV3 and INV4 in FIG. 10, and a clock inverter CKINV corresponds to the inverter INV2 in FIG. 10. Hereinafter, descriptions repeated with FIGS. 8A through 9B may be omitted.

Referring to FIG. 11A, the hybrid standard cell HSC3 includes a first power rail PR1, a second power rail PR2, a third power rail PR3, and a plurality of sub regions divided by first through fourth active break regions ABR1˜ABR4. A first row region RG1 between the first power rail PR1 and the second power rail PR2 may include a first low-power transistor region LPTR1, a second low-power transistor region LPTR2 and a first high-speed transistor region HSTR1 that are arranged sequentially in the first direction X. A second row region RG2 between the second power rail PR2 and the third power rail PR3 may include a second high-speed transistor region HSTR2, a third low-power transistor region LPTR3 and a third high-speed transistor region HSTR3 that are arranged sequentially in the first direction X.

As illustrated in FIG. 11A, the first low-power transistor region LPTR1 may include the scan enable inverter SEINV and a first portion of the input multiplexer IMUX, the second low-power transistor region LPTR may include the first master latch ML1 and the first slave latch SL1, the first high-speed transistor region HSTR1 may include the first output driver ODRV1, the second high-speed transistor region HSTR2 may include a second portion of the input multiplexer IMUX and the clock inverter CKINV, the third low-power transistor region LPTR3 may include the second master latch ML2 and the second slave latch SL2, and the third high-speed transistor region HSTR3 may include the second output driver ODRV2.

The normal standard cell NSC3 of FIG. 11B is substantially the same as the hybrid standard cell HSC3 of FIG. 11A, except that the first, second and third low-power transistor regions LPTR1, LPTR2 and LPTR3 of FIG. 11A are replaced with fourth, fifth and sixth high-speed transistor regions HSTR4, HSTR5 and HSTR6 of FIG. 11B. Therefore, repeated descriptions are omitted.

FIGS. 12A and 12B are cross-sectional views of a standard cell that may have the same layout as the standard cell of FIG. 3.

FIGS. 12A and 12B illustrate a portion of the standard cell SCL that includes multi-bridge channel field effect transistor (MBCFET). FIG. 12A is a cross-sectional view of the standard cell SCL of FIG. 3 cut along a line A-A′. FIG. 12B is a cross-sectional view of the standard cell SCL of FIG. 3 cut along a line C-C′.

Referring to FIGS. 11A and 12B, the standard cell SCL of FIG. 3 may include an active pattern 105, a growth prevention pattern 225, a gate structure 330, a semiconductor pattern 124, and a source/drain layer 250 on the substrate 100. The standard cell SCL may further include a gate spacer 185, an inner spacer 220, an isolation pattern 130, and an insulation layer 270.

The active pattern 105 may protrude from the substrate 100 in the third direction and may extend in the first direction. In the figures, two active patterns 105 are shown, however, the inventive concept may not be limited thereto. Therefore, more than two active patterns 105 may be spaced apart from each other in the second direction. The active pattern 105 may be formed by partially removing an upper portion of the substrate 100. Therefore, the active pattern 105 may include a material substantially the same as that of the substrate 100.

A sidewall of the active pattern 105 may be covered by the isolation pattern 130. The isolation pattern 130 may include an oxide, e.g., silicon oxide. A first recess 195 may be formed on an upper surface of the active pattern 105 to have a cross-section in the first direction with a “V” shape. The growth prevention pattern 225 may be formed on the first recess 195. A portion of the growth prevention pattern 225 on a central portion of the first recess 195 in the first direction may have a greatest thickness, and a portion of the growth prevention pattern 225 on each of opposite edges of the first recess 195 in the first direction may have a smallest thickness. In some example embodiments, the growth prevention pattern 225 may entirely cover an upper surface of the active pattern 105 exposed by the first recess 195.

A plurality of semiconductor patterns 124 may be formed at a plurality of levels, respectively, to be spaced apart from each other in the third direction from an upper surface of the active pattern 105. In the figures, the semiconductor patterns 124 are shown at three levels, respectively, however, the inventive concept may not be limited thereto.

The semiconductor patterns 124 may be nanowire or nanosheets including semiconductor materials such as silicon, germanium, etc. The semiconductor patterns 124 may function as electrical channels of transistors. Therefore, the semiconductor patterns 124 may be referred to as “channels”.

The gate structure 330 may be formed on the substrate 100 and may surround a central portion of the semiconductor pattern 124 in the first direction. In the figures, the gate structure 330 is shown to cover the semiconductor patterns 124 on two active patterns 105, however, the inventive concept may not be limited thereto. In other words, the gate structure 330 may extend in the second direction Y on the substrate 100 with the isolation pattern 130 thereon, and may cover the semiconductor patterns 124 on more than two active patterns 105 spaced apart from each other in the second direction Y.

In the figures, two gate structures 330 are shown on the substrate 100, however, the inventive concept may not be limited thereto. For example, more than two gate structures 330 spaced apart from each other in the first direction may be formed on the substrate 100.

The gate structure 330 may be formed on a portion of the active pattern 105 at each of opposite sides of the first recess 195 in the first direction. The gate structure 330 may include an interface pattern 290, a gate insulation pattern 300, a work function control pattern 310, and a gate electrode 320 sequentially stacked from a surface of each of the semiconductor patterns 124 or the upper surface of the active pattern 105.

The interface pattern 290 may be formed on the upper surface of the active pattern 105 and the surfaces of the semiconductor patterns 124. The gate insulation pattern 300 may be formed on a surface of the interface pattern 290, the inner sidewalls of the gate spacer 185, and the inner spacer 220. The work function control pattern 310 may be formed on the gate insulation pattern 300. The gate electrode 320 may fill a space between the semiconductor patterns 124 spaced apart from each other in the third direction and the inner spacers 220 spaced apart from each other in the first direction. The gate electrode 320 may also fill a space between the gate spacers 185 spaced apart from each other in the first direction on an uppermost one of the semiconductor patterns 124.

The gate structure 330 may be electrically insulated from the source/drain layer 250 by the gate spacer 185 and the inner spacer 220. The gate spacer 185 may cover each of opposite sidewalls of an upper portion of the gate structure 330 in the first direction. The inner spacer 220 may cover each of opposite sidewalls of a lower portion of the gate structure 330 in the first direction.

In some example embodiments, the inner spacer 220 may have a cross-section in the first direction with a shape of a horseshoe or a shape of a semicircle with a recess on an outer sidewall thereof. Alternatively, the inner spacer 220 may have a cross-section in the first direction with a shape of a rounded rectangle with a recess on an outer sidewall thereof.

The source/drain layer 250 may extend in the third direction on the growth prevention pattern 225 and may commonly contact respective sidewalls of the semiconductor patterns 124 in the first direction at the plurality of levels to be connected thereto.

The source/drain layer 250 may include first and second epitaxial layers 230 and 240. In some example embodiments, each of the first epitaxial layers 230 may protrude from the sidewall of each of the semiconductor patterns 124 in the first direction X, and may have a cross-section in the first direction X with a shape of, e.g., a candle or an ellipse. In some example embodiments, the second epitaxial layer 240 may extend from the growth prevention pattern 225 in the third direction to contact a lower sidewall of the gate spacer 185.

In some example embodiments, each of the first and second epitaxial layers 230 and 240 may include single crystalline silicon carbide doped with n-type impurities or single crystalline silicon doped with n-type impurities. The first and second epitaxial layers 230 and 240 may have first and second impurity concentrations, respectively, and the second impurity concentration may be greater than the first impurity concentration.

In some example embodiments, the first epitaxial layer 230, the second epitaxial layer 240, and another first epitaxial layer 230 may be sequentially arranged in the source/drain layer 250 between neighboring ones of the semiconductor patterns 124 in the first direction at the same level. In this case, the source/drain layer 250 may have a varying impurity concentration in the first direction, e.g., the first impurity concentration, the second impurity concentration and the first impurity concentration in the first direction.

In some example embodiments, a first air gap 260 may be formed between the source/drain layer 250 and the growth prevention pattern 225 due to the crystallinity of the second epitaxial layer 240, and a second air gap 265 may be formed between the source/drain layer 250 and the inner spacer 220.

Since the source/drain layer 250 may include impurities, the gate structure 330, the source/drain layer 250, and each of the semiconductor patterns 124 serving as a channel may form an MBCFET. A plurality of semiconductor patterns 124 may be sequentially stacked in the third direction Z.

The insulation layer 270 may surround an outer sidewall of the gate spacer 185 to cover the source/drain layer 250. The insulation layer 270 may include an oxide, e.g., silicon oxide.

FIGS. 13A and 13B are diagrams illustrating an example embodiment of a layout of a hybrid standard cell corresponding to the 1-bit flip-flop of FIG. 7.

FIG. 13A illustrates a hybrid standard cell HSC4 with a multi-bridge channel (MBC) structure and FIG. 13B illustrates a corresponding normal standard cell NSC4. The standard cells HSC4 and NSC4 of FIGS. 13A and 13B are substantially the same as the standard cells HSC1 and NSC1 of FIGS. 8A and 8B, except that the fins FN1˜FN4 of FIGS. 8A and 8B are replaced with nanosheets NSH1 and NSH2 of FIGS. 13A and 13B, and the repeated descriptions are omitted.

As illustrated in FIG. 13A, the width of the nanosheets NSH1 and NSH2 formed in the first and second high-speed transistor regions HSTR1 and HSTR2 is greater than the width of the nanosheets NSH1 and NSH2 formed in the first low-power transistor region LPTR1. Accordingly, the high-speed transistors with the higher operation speed may be formed in the first and second high-speed transistor regions HSTR1 and HSTR2, whereas the low-power transistors with the lower power consumption may be formed in the first low-power transistor region LPTR1.

As such, the layout of the fin-structure as illustrated in FIGS. 8A, 8B, 9A, 9B, 11A and 11B may be applied to the layout of the nanowire structure of FIG. 2B and/or the layout of the nanosheet structure of FIG. 2C. Additionally or alternatively, the described example embodiments may be applied to any structures other than the fin-structure, the nanowire structure and the nanosheet structure.

FIG. 14 is a flow chart illustrating a method of designing an integrated circuit according to example embodiments.

The method of FIG. 14 may be performed by a design tool. In some example embodiments, the design tool may include a plurality of instructions executed by a processor. An integrated circuit may be defined by a plurality of cells and the integrated circuit may be designed using a cell library including information of the plurality of cells. Hereinafter, a cell or a standard cell may include normal standard cells and a hybrid standard cells, and a cell library may be a normal standard cell library or a hybrid standard cell library.

Referring to FIG. 14, input data defining the integrated circuit may be received (S100). In some example embodiments, the input data may be data generated from an abstract form with respect to behavior of the integrated circuit. For example, the input data may be defined in a register transfer level (RTL) through synthesis using the standard cell library. For example, the input data may be a bitstream or a netlist generated by synthesizing the integrated circuit defined by a hardware description language (HDL) such as VHSIC hardware description language (VHDL) or Verilog.

In some example embodiments, the input data may be data for defining the layout of the integrated circuit. For example, the input data may include geometric information for defining a structure implemented as a semiconductor material, a metal, and an insulator. A layer of the integrated circuit indicated by the input data may have a layout of the cells and conducting wires used to connect a cell to other cells, for example.

A normal standard cell library including a plurality of normal standard cells may be provided (S200). Additionally or alternatively, a hybrid standard cell library including at least one hybrid standard cell may be provided (S300). The hybrid standard cell has the same function as a corresponding normal standard cell among the plurality of normal standard cells and has a lower power consumption than the corresponding normal standard cell.

The term “standard cell” may refer to a unit of an integrated circuit in which a size of the layout meets a preset rule. The standard cell may include an input pin and an output pin. The standard cell may process a signal received through the input pin to output a signal through the output pin. For example, the standard cell may be a basic cell such as an AND logic gate, an OR logic gate, a NOR logic gate, or an inverter, a complex cell such as an OR/AND/INVERTER (OAI) or an AND/OR/INVERTER (AOI), and a storage element such as a master-slave flip flop or a latch.

The standard cell library may include information about a plurality of standard cells. For example, the standard cell library may include a name and a function of a standard cell, as well as timing information, power information, and layout information of the standard cell. The standard cell library may be stored in a storage device and the standard cell library may be provided by accessing the storage device.

Output data may be generated by performing placement and routing based on the input data, the normal standard cell library and the hybrid standard cell library (S400).

In some example embodiments, when the received input data are data such as a bitstream or a netlist generated by synthesizing the integrated circuit, the output data may be the bitstream or the netlist. In some example embodiments, when the received input data are data defining the layout of the integrated circuit, for example, data with a graphic data system II (GDSII) format, a format of the output data may also be data defining the layout of the integrated circuit.

According to example embodiments, design efficiency may be enhanced using the hybrid standard cell with the same function as the corresponding normal standard cell and with the lower power consumption than the corresponding normal standard cell. For example, if a design is modified after cell placement, a normal cell may be replaced with a hybrid cell that can perform the same function yet with lower power consumption. Thus, the design might be made to satisfy power consumption requirements without inefficient redesign efforts.

FIG. 15A is a block diagram illustrating a designing system of an integrated circuit according to example embodiments.

Referring to FIG. 15A, a designing system 1000 may include a storage medium 1100, a designing module 1400 and a processor 1500.

The storage medium 1100 may store a normal standard cell library NSCLB 1110 and a hybrid standard cell library HSCLB 1120. The normal standard cell library 1110 and the hybrid standard cell library 1120 may be provided from the storage medium 1100 to the designing module 1400.

The storage medium or the storage device 1100 may include any non-transitory computer-readable storage medium used to provide commands and/or data to a computer. The non-transitory computer-readable storage medium 1100 may be inserted into the computer, may be integrated in the computer, or may be coupled to the computer through a communication medium such as a network and/or a wireless link.

The designing module 1400 may include a placement module PLMD 1200 and a routing module RTMD 1300. Herein, the term “module” may indicate, but is not limited to, a software and/or hardware component, such as a field programmable gate array (FPGA) or an application specific integrated circuit (ASIC), which performs certain tasks. A module may be configured to reside in a tangible addressable storage medium and be configured to execute on one or more processors.

The placement module 1200 may, using the processor 1500, arrange normal standard cells and/or hybrid standard cells based on input data DI defining the integrated circuit, the normal standard cell library 1110 and the hybrid standard cell library 1120. The routing module 1300 may perform signal routing with respect to the cell placement provided from the placement module 1200. If the routing is not successful, the placement module 1200 may modify the previous cell placement and the routing module 1300 may perform the signal routing with the modified cell placement. When the routing is successfully completed, the routing module 1300 may provide output data DO defining the integrated circuit.

FIG. 15B is a flow chart illustrating an example operation of the designing system of FIG. 15A.

Referring to FIGS. 15A and 15B, the designing module 1400 may receive the input data DI defining the integrated circuit (S11). The placement module 1200 may refer to the normal standard cell library 1110 used to extract normal standard cells corresponding to the input data DI and perform cell placement using the extracted normal standard cells (S12). The routing module 1300 may perform signal routing with respect to the placed cells (S13). When the signal routing is not successful (S14: NO), the placement module 1200 may change the cell replacement (S15), and the routing module 1300 may perform signal routing again with respect to the changed cell placement (S13).

When the signal routing is successful (S14: YES), the designing module 1400 may determine if the routed integrated circuit satisfies power condition (S16). The designing module 1400 may determine that the power condition is not satisfied, when the power consumption is higher than a target value.

When the power condition is not satisfied (S16: NO), the designing module 1400 may replace at least one normal standard cell with a corresponding hybrid standard cell (S17).

When the power condition is satisfied (S16: YES), the designing module 1400 may generate the output data DO defining the integrated circuit (S18).

As such, design efficiency may be enhanced by replacing the normal standard cell with the hybrid standard cell after replacement and routing are completed.

Thus, according to example embodiments, a method of designing an integrated circuit includes receiving input data for an integrated circuit; performing placement using normal standard cells based on the input data; performing signal routing based on the placement; determining that a power condition is not satisfied based at least in part on the placement and the signal routing; replacing at least one of the normal standard cells with a hybrid standard cell based on the determination; and generating output data for the integrated circuit based on the hybrid standard cell.

In some cases, the method includes identifying a normal standard cell library including the normal standard cells, wherein the placement is based on the normal standard library; and identifying a hybrid standard cell library including the hybrid standard cell, wherein the hybrid standard cell is configured to perform a same function as at least one of the normal standard cells, the hybrid standard cell has a lower power consumption than the at least one of the normal standard cells, and wherein the replacing is performed based on the hybrid standard cell library.

In some cases, the method includes determining that the signal routing is not successful; and changing the placement based on the determination that the signal routing is not successful, wherein the determination that the power condition is not satisfied is based on the changing of the placement.

FIG. 16 is a diagram illustrating pin points of the standard cell of FIG. 3, and FIGS. 17A and 17B are diagrams for describing pin points for signal output and signal input of a cell.

For convenience, only the wirings, for example, first through eighth wirings 71˜78 among the elements in FIG. 3 are illustrated in FIG. 16. Additionally or alternatively, the routing grids or the routing tracts, for example, first through fifth tracts TR1˜TR5, which are formed over the standard cell SCL, are illustrated together in FIG. 16.

The cross points of the wirings 71˜78 of the standard cell SCL and the routing tracts TR1˜TR5 may correspond to pin points for signal output and signal input. A pin point may indicate a position that may electrically connect one of the wirings 71˜78 of the standard cell SCL to one of the routing tracts TR1˜TR5 through a vertical contact such as a via contact. The pin point may be referred to as a pin target or a pin position.

FIGS. 17A and 17B illustrate a multi-layer wiring structure including, for example, lower wirings M11 and M12 and upper wirings M2a M2b and M2c. As illustrated in FIGS. 17A and 17B, the lower wirings M11 and M12 may be extended, in parallel, to each other in the second direction Y and the upper wirings M2a, M2b and M2c may be extended, in parallel, to each other in the first direction X. The lower wirings M11 and M12 may correspond to the above-described wirings of the standard cell and the upper wirings M2a, M2b and M2c may correspond to the above-described routing tracts.

The cross points of the lower wirings M11 and M12 and the upper wirings M2a, M2b and M2c may be pin points P1a, P1b, P1c, P2a, P2b and P2c. FIG. 17B illustrates an example signal routing. Via contacts V1a and V1b may be formed at the two pin points P1a and P2b to electrically connect the first lower wiring M11 and the first upper wiring M2a and electrically connect the second lower wiring M12 and the second upper wiring M2b.

The hybrid standard cell HSC and the corresponding normal standard cell NSC may have the different lower structure related with the channel of transistor and the same upper structure related with routing, and the layout of FIG. 16 may be common to the hybrid standard cell HSC and the corresponding normal standard cell NSC. In other words, the pin points for signal output and signal input of the hybrid standard cell HSC may coincide with the pin points for signal output and signal input of the corresponding normal standard cell NSC.

As such, with maintaining the already optimized routing, the normal standard cell may be replaced with the corresponding hybrid standard cell, according to example embodiments. According to example embodiments, the normal standard cell, including the high-speed transistors, may be replaced with the hybrid standard cell, including the high-speed transistors and the low-power transistors, when the power consumption of the already-routed integrated circuit may be reduced. Alternatively, when the operation speed of the already-routed integrated circuit may be increased, the normal standard cell including the low-power transistors may be replaced with the hybrid standard cell including the high-speed transistors and the low-power transistors according to example embodiments.

FIG. 18 is a diagram illustrating a layout of an integrated circuit according to example embodiments.

An integrated circuit 3000 of FIG. 18 may be an application specific integrated circuit (ASIC). A layout of the integrated circuit 3000 may be determined by performing the above-described placement and routing of normal standard cells SC1˜SC12. Power may be provided to the standard cells SC1˜SC12 through power rails 311˜316. The power rails 311˜316 may include high power rails 311, 313, and 315 to provide a first power supply voltage VDD, and low power rails 312, 314, and 316 to provide a second power supply voltage VSS lower than the first power supply voltage VDD. For example, the first power supply voltage VDD may have a positive voltage level and the second power supply voltage VSS may have a ground level (e.g., 0V) or a negative voltage level.

The high power rails 311, 313, and 315, and the low power rails 312, 314, and 316 extend in the first direction X and are arranged alternatively one by one in the second direction Y to form boundaries of a plurality of circuit rows CR1˜CR5 corresponding to the regions defined by the power rails 311˜316 arranged in the second direction Y.

According to some example embodiments, power may be distributed to the power rails 311˜316 through power mesh routes 321˜324 that extend in the second direction Y. Some power mesh routes 322 and 324 may provide the first power supply voltage VDD and other power mesh routes 321 and 323 may provide the second power supply voltage VSS. The power mesh routes 321˜324 may be connected to the power rails 311˜316 through vertical contacts VC such as via contacts.

In general, each of the circuit rows CR1˜CR5 may be connected to two adjacent power rails that are at boundaries thereof to be powered. For example, the standard cells SC1, SC2, SC3, and SC4 in the first circuit row CR1 may be connected to an adjacent and corresponding power rail pair including the high power rail 311 and the low power rail 312.

For example, as illustrated in FIG. 18, the standard cell SC6 may be a double-height standard cell formed in the two circuit rows CR2 and CR3 and the standard cell SC7 may be a triple-height standard cell formed in the three circuit rows C2, C3 and C4. As such, the area occupied by the integrated circuit 300 may be reduced and the performance of the integrated circuit 300 may be enhanced by efficient routing of the single-height standard cells SC1˜SC5 and SC8˜SC12 and the multi-height standard cells SC6 and SC7.

FIG. 18 also illustrates an integrated circuit 3001 in which the normal standard cells NSC4, NSC7, NSC6 and NSC11 in the integrated circuit 3000 are replaced with hybrid standard cells HSC4, HSC7, HSC6 and HSC11. As such, with maintaining the already optimized routing of the integrated circuit 3000, the normal standard cells may be replaced with the corresponding hybrid standard cells, to provide the integrated circuit 3001 with the power consumption and/or the operation speed different from the integrated circuit 3000.

FIG. 19 is a block diagram illustrating a mobile device according to example embodiments.

Referring to FIG. 19, a mobile device 4000 may include at least one application processor 4100, a communication module 4200, a display/touch module 4300, a storage device 4400, and a buffer RAM 4500.

The application processor 4100 may control operations of the mobile device 4000. The communication module 4200 is implemented to perform wireless or wire communications with an external device. The display/touch module 4300 is implemented to display data processed by the application processor 4100 and/or to receive data through a touch panel. The storage device 4400 is implemented to store user data. The storage device 4400 may be an embedded multimedia card (eMMC), a solid state drive (SSD), a universal flash storage (UFS) device, etc. The storage device 4400 may perform caching of the mapping data and the user data as described above.

The buffer RAM 4500 may temporarily store data used for processing operations of the mobile device 4000. For example, the buffer RAM 4500 may be volatile memory such as double data rate (DDR) synchronous dynamic random access memory (SDRAM), low power double data rate (LPDDR) SDRAM, graphics double data rate (GDDR) SDRAM, Rambus dynamic random access memory (RDRAM), etc.

At least one component in the mobile device 4000 may include at least one hybrid standard cell according to example embodiments. As described above, the hybrid standard cell may be included in the standard cell library. Integrated circuits included in the mobile device 4000 may be designed efficiently through automatic placement and routing by a design tool.

Embodiments may be applied to any electronic devices and systems. For example, embodiments may be applied to systems such as be a memory card, a solid state drive (SSD), an embedded multimedia card (eMMC), a mobile phone, a smart phone, a personal digital assistant (PDA), a portable multimedia player (PMP), a digital camera, a camcorder, personal computer (PC), a server computer, a workstation, a laptop computer, a digital TV, a set-top box, a portable game console, a navigation system, a wearable device, an internet of things (IoT) device, an internet of everything (IoE) device, an e-book, a virtual reality (VR) device, an augmented reality (AR) device, etc.

The foregoing is illustrative of example embodiments and is not to be construed as limiting thereof. Although a few example embodiments have been described, those skilled in the art will readily appreciate that many modifications are possible in the example embodiments without materially departing from the present inventive concept.

1. A hybrid standard cell for an integrated circuit, the hybrid standard cell comprising:
a semiconductor substrate;
a first power rail and a second power rail formed above the semiconductor substrate, wherein the first power rail and the second power rail extend in a first direction and are arranged sequentially in a second direction perpendicular to the first direction; and
a high-speed transistor region and a low-power transistor region adjacent to the high-speed transistor region in the first direction and arranged in a row region between the first power rail and the second power rail, an operation speed of a high-speed transistor formed in the high-speed transistor region being higher than an operation speed of a low-power transistor formed in the low-power transistor region, and a power consumption of the high-speed transistor being lower than a power consumption of the high-speed transistor.

2. The hybrid standard cell of claim 1, wherein a boundary of the high-speed transistor region and the low-power transistor region corresponds to an active break region extending in the second direction, the active break region being used to cut transistor channels.

3. The hybrid standard cell of claim 1, wherein a first channel width of the high-speed transistor is greater than a second channel width of the low-power transistor.

4. The hybrid standard cell of claim 1, wherein the high-speed transistor and the low-power transistor are each implemented as a fin field effect transistor (FinFET), and a number of semiconductor fins formed in the high-speed transistor region is greater than a number of semiconductor fins formed in the low-power transistor region.

5. The hybrid standard cell of claim 1, wherein the high-speed transistor and the low-power transistor are each implemented as a multi-bridge channel field effect transistor (MBCFET), and wherein a number of channels formed in the high-speed transistor is greater than a number of channels formed in the low-power transistor or a width of channels formed in the high-speed transistor is greater than a width of channels formed in the low-power transistor.

6. The hybrid standard cell of claim 1, wherein the hybrid standard cell corresponds to a flip-flop, and a clock inverter and an output driver included in the flip-flop are formed in the high-speed transistor region.

7. A hybrid standard cell for an integrated circuit, the hybrid standard cell comprising:
a semiconductor substrate;
a plurality of power rails formed above the semiconductor substrate, extending in a first direction, and arranged sequentially in a second direction perpendicular to the first direction; and
at least one high-speed transistor region and at least one low-power transistor region arranged in one or more row regions between the plurality of power rails, wherein one or more boundaries of the at least one high-speed transistor region and the at least one low-power transistor region correspond to one or more active break regions extending in the second direction, a first channel width of a high-speed transistor formed in the at least one high-speed transistor region being greater than a second channel width of a low-power transistor formed in the at least one low-power transistor region.

8. The hybrid standard cell of claim 7, wherein an operation speed of the high-speed transistor is higher than an operation speed of the low-power transistor and a power consumption of the high-speed transistor is lower than the high-speed transistor.

9. The hybrid standard cell of claim 7, wherein the plurality of power rails include a first power rail and a second power rail that are arranged sequentially in the second direction, and
wherein the hybrid standard cell includes a 1-bit flip-flop formed in a row region between the first power rail and the second power rail.

10. The hybrid standard cell of claim 9, wherein the row region between the first power rail and the second power rail is divided by a first active break region, a second active break region, a third active break region and a fourth active break region arranged sequentially in the first direction, and
wherein the row region between the first power rail and the second power rail includes a first low-power transistor region, a first high-speed transistor region and a second high-speed transistor region arranged sequentially in the first direction.

11. The hybrid standard cell of claim 10, wherein the first low-power transistor region includes a scan enable inverter, an input multiplexer and a master latch,
wherein the first high-speed transistor region includes a clock inverter and a slave latch, and
wherein the second high-speed transistor region includes an output driver.

12. The hybrid standard cell of claim 9, wherein the row region between the first power rail and the second power rail is divided by a first active break region, a second active break region, a third active break region and a fourth active break region arranged sequentially in the first direction, and
wherein the row region between the first power rail and the second power rail includes a first high-speed transistor region, a first low-power transistor region and a second high-speed transistor region arranged sequentially in the first direction.

13. The hybrid standard cell of claim 12, wherein the first high-speed transistor region includes a scan enable inverter, an input multiplexer and a clock inverter,
wherein the first low-power transistor region includes a master latch and a slave latch, and
wherein the second high-speed transistor region includes an output driver.

14. The hybrid standard cell of claim 7, wherein the plurality of power rails include a first power rail, a second power rail and a third power rail arranged sequentially in the second direction, and
wherein the hybrid standard cell includes a 2-bit flip-flop formed in a first row region between the first power rail and the second power rail and a second row region between the second power rail and the third power rail.

15. The hybrid standard cell of claim 14, wherein the first row region and the second row region are divided by a first active break region, a second active break region, a third active break region and a fourth active break region arranged sequentially in the first direction,
wherein the first row region includes a first low-power transistor region, a second low-power transistor region and a first high-speed transistor region arranged sequentially in the first direction, and
wherein the second row region includes a second high-speed transistor region, a third low-power transistor region and a third high-speed transistor region arranged sequentially in the first direction.

16. The hybrid standard cell of claim 15, wherein the first low-power transistor region includes a scan enable inverter and a first portion of an input multiplexer,
wherein the second low-power transistor region includes a first master latch and a first slave latch,
wherein the first high-speed transistor region includes a first output driver,
wherein the second high-speed transistor region includes a second portion of the input multiplexer and a clock inverter,
wherein the third low-power transistor region includes a second master latch and a second slave latch, and
wherein the third high-speed transistor region includes a second output driver.

17-20. (canceled)

21. A method of designing an integrated circuit, the method comprising:
receiving input data for an integrated circuit;
performing placement using normal standard cells based on the input data;
performing signal routing based on the placement;
determining that a power condition is not satisfied based at least in part on the placement and the signal routing;
replacing at least one of the normal standard cells with a hybrid standard cell based on the determination; and
generating output data for the integrated circuit based on the hybrid standard cell.

22. The method of claim 21, further comprising:
identifying a normal standard cell library including the normal standard cells, wherein the placement is based on the normal standard library; and
identifying a hybrid standard cell library including the hybrid standard cell, wherein the hybrid standard cell is configured to perform a same function as at least one of the normal standard cells, the hybrid standard cell has a lower power consumption than the at least one of the normal standard cells, and wherein the replacing is performed based on the hybrid standard cell library.

23. The method of claim 21, further comprising:
determining that the signal routing is not successful; and
changing the placement based on the determination that the signal routing is not successful, wherein the determination that the power condition is not satisfied is based on the changing of the placement.
